(19) United States
(12) Patent Application Publication
(10) Pub. No.: US 2010/0190134 A1
(43) Pub. Date: Jul. 29, 2010

(54) LIP RETRACTOR FOR INTRAORAL PHOTOGRAPHY

(76) Inventor: Hyo-Sang Park, Daegu (KR)

Correspondence Address: NIXON PEABODY, LLP, 401 9TH STREET, NW, SUITE 900, WASHINGTON, DC, 20004-2128, US

(21) Appl. No.: 12/358,264

(22) Filed: Jan. 23, 2009

(51) Int. Cl. A61C 3/00

(52) U.S. Cl. 433/140

(57) ABSTRACT

Disclosed therein is a lip retractor for intraoral photography. The lip retractor (1) includes: a rectangular lip retracting member (3); and a handle (2) formed on one side of the lip retracting member (3) and having a slope of a predetermined degree, the handle (2) including an air path (4) and an air injection hole (5) formed on the inside thereof to thereby inject air to a miller during intraoral photography. The lip retractor for intraoral photography can more easily and conveniently retract the lips with one hand during intraoral photography and prevent frost formed on a miller by the steam of breath to thereby obtain a clearer image.

### BACKGROUND OF THE INVENTION

1. Field of the Invention

The present invention relates to a lip retractor for intraoral photography, and more particularly, to a lip retractor for intraoral photography, which can more easily open and retract the lips while a dentist or a dental photographer takes a photo of the occlusal surface for orthodontics and prevent frost formed on a miller by the steam of breath.

2. Background Art

In general, in dental surgery, a dentist or a dental photographer takes a photo of the occlusal surface to obtain data necessary for orthodontics, and in this instance, he or she takes the photo in a state where the lips of a patient are opened and retracted to obtain a more exact image.

As shown in FIG. 1, a conventional lip retractor 100 for intraoral photography includes a curved handle 200 formed on a top portion thereof, and a hook 400 formed integrally on a bottom portion thereof and having a horseshoe-shaped lip retracting groove 300.

However, as shown in FIG. 2, the conventional lip retractor 100 has several problems in that it is inconvenient in use and interfered during the intraoral photography since the conventional lip retractors 100 requires two pieces fit at both sides of the lips and pulled with the two hands.

Moreover, the conventional lip retractor 100 has another problem in that it cannot prevent frost formed on a miller by the steam of breath during the intraoral photography since it has no means to defrost the miller, which is put in the patient's mouth to obtain a more exact image for the intraoral photography, and hence, the intraoral photography must be repeated several times to obtain a clearer image.

### SUMMARY OF THE INVENTION

Accordingly, the present invention has been made to solve the above-mentioned problems occurring in the prior arts, and it is an object of the present invention to provide a lip retractor for intraoral photography, which can more easily and conveniently retract the lips with one hand during intraoral photography and prevent frost formed on a miller by the steam of breath, thereby obtaining a clearer image.

To accomplish the above object, according to the present invention, there is provided a lip retractor for intraoral photography comprising: a handle formed in such a way that a dentist can retract the lips with one hand; a lip retracting member formed at a lower portion of the handle in an arc shape like the lips; and an air injector fixed or an air hose of a dental air compressor connected to the handle to thereby defrost a miller by injecting air, which is supplied through an air path formed inside the handle, to the miller.

As described above, the lip retractor for intraoral photography according to the present invention which can easily and conveniently retract the lips with one hand during intraoral photography and prevent frost formed on a miller by the steam of breath in such a way as to jet air to the miller, thereby obtaining a clearer image.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a conventional lip retractor for intraoral photography;

FIG. 2 is a view showing a lip retracting state during the intraoral photography using the conventional lip retractor;

FIG. 3 is an exemplary view of intraoral photography;

FIG. 4 is a perspective view of a lip retractor for intraoral photography according to a preferred embodiment of the present invention;

FIG. 5 is a sectional view of the lip retractor for intraoral photography according to the present invention; and

FIGS. 6 and 7 are views of a lip retractor for intraoral photography according to another preferred embodiment of the present invention.

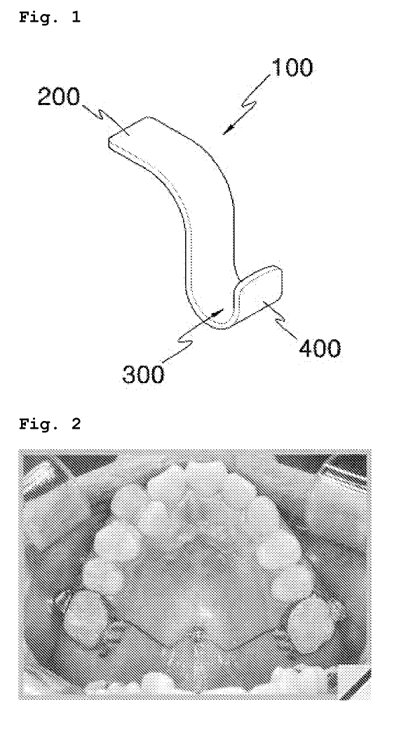

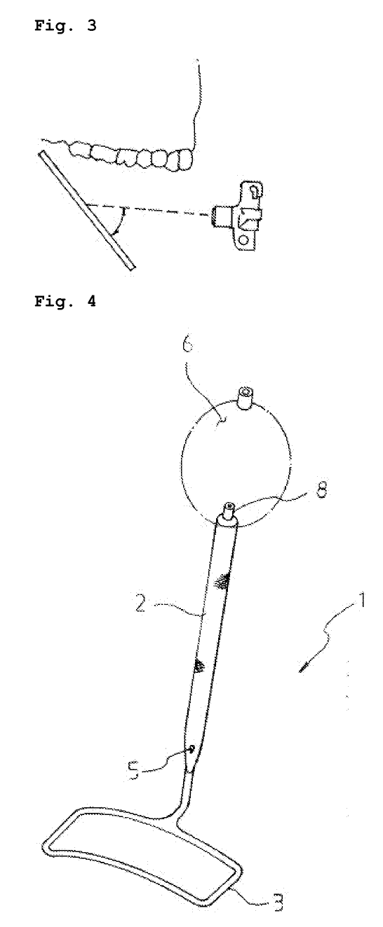

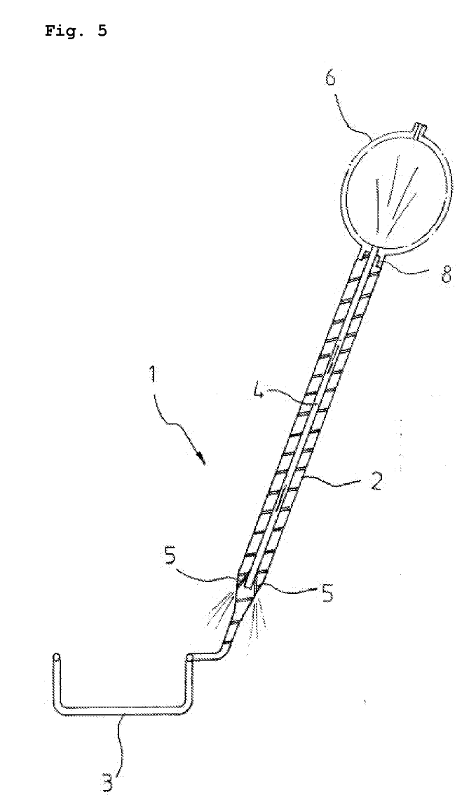

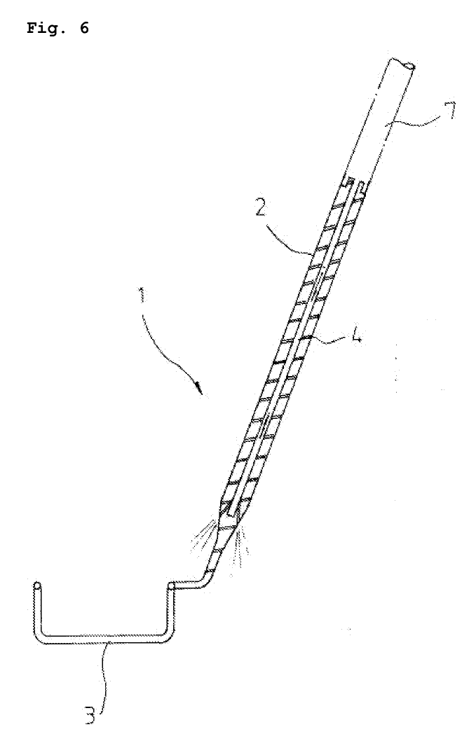

### DETAILED DESCRIPTION OF THE PREFERRED EMBODIMENT

Reference will be now made in detail to the preferred embodiment of the present invention with reference to the attached drawings.

A lip retractor 1 for intraoral photography according to the present invention includes: a handle 2; a lip retracting member 3 formed integrally with a lower portion of the handle 2; and an air injector 6 connected to an end of the handle 2 for compressing and injecting air.

The handle 2 is formed at the central portion of one side of the lip retracting member 3, and has a slop of a predetermined degree in such a way as to easily and conveniently retract the lips. It is preferable that the slop of the handle 2 is about 50° to 60°.

The air injector 6 is fixed or a connector 8 for connecting air hose 7 connected with a dental air compressor is formed at the end of the handle 2, and an air path 4 is formed in the inner center of the handle 2. Furthermore, an air injection hole 5 is formed at an end of the air path 4.

The lip retracting member 3 is made of titanium, which does not injure the gum or the lips and is incorrodible, and curved in the same form and size as the lips so as to pull and retract the lips at a time, and generally formed in a rectangle.

Moreover, the rectangular lip retractor 3 has an inner space to thereby reduce a rejection feeling when the lips are retracted, prevent interference during the intraoral photography, and promote a flow of air injected to a miller to remove frost.

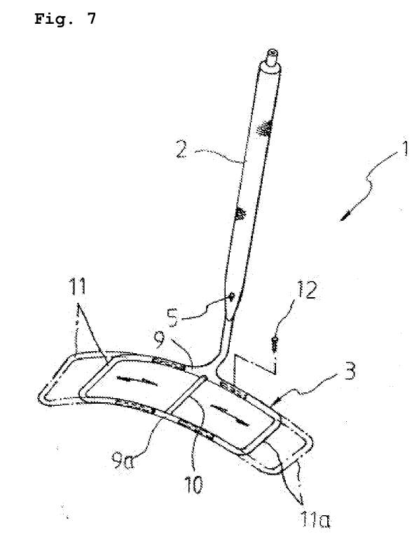

In addition, as shown in FIG. 7, the lip retracting member 3 includes: two sleeves 9 and 9a supported by a supporter 10 located at a lower portion of the handle 2; [symbol] -shaped sliders 11 and 11a respectively inserted into both sides of the sleeves 9 and 9a; and screws 12 fastened to the inserted portions, so that the lip retracting member 3 is adjustable in its width and curved level according to the size of the lips of the patient.

As described above, the air injector 6 for defrosting the miller is fixed to an end of the handle 2 of the lip retractor 1. When the air injector 6 is compressed, the outside air is introduced into the lip retractor 1 and injected to the air injection hole 5 through the air path 4 by pressure.

As another air-injecting means of the lip retractor 1 for the intraoral photography according to the present invention, the air hose 7 of the dental air compressor used for dental surgery is connected to the connector 8 formed at the end of the handle 2 of the lip retractor 1 to thereby inject air to the miller.

In order to take a photo of the occlusal surface for orthodontics, after opening the patient's lips, the dentist inserts the lip retracting member 3 to the inside of the lips and draws out the lips while grasping the handle 2 of the lip retractor 1 for intraoral photography with one hand, and hence, the lip retractor according to the present invention can easily and conveniently retract the lips. As described above, in a state where the lips are retracted, when the air injector 6 fixed to the end of the handle 2 of the lip retractor 1 is compressed, the air introduced from the outside is injected to the air injection hole 5 through the air path 4 by pressure, whereby the present invention can remove frost formed on the miller by the steam of breath.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A lip retractor for intraoral photography comprising:
a rectangular lip retracting member; and
a handle formed on one side of the lip retracting member and having a slope of a predetermined degree.

2. The lip retractor according to claim 1, wherein the handle comprises an air path and an air injection hole formed on the inside of the handle to thereby inject air to a miller during intraoral photography.

3. The lip retractor according to claim 1, wherein the lip retracting member comprises:
two sleeves supported by a supporter located at a lower portion of the handle; [symbol]
-shaped sliders respectively inserted into both sides of the sleeves; and
screws fastened to the inserted portions,
whereby the lip retracting member is adjustable in its width and curved level according to the size of the lips of the patient.

4. The lip retractor according to claim 2, wherein an air injector is fixed or an air hose of an air compressor is connected to an end of the handle having the air path and the air injection hole to thereby supply air.
